(19) United States
(12) Patent Application Publication
(10) Pub. No.: US 2025/0131938 A1
(43) Pub. Date: Apr. 24, 2025

(54) SPEECH PROCESSING METHOD, DEVICE AND STORAGE MEDIUM

(71) Applicant: Zhejiang Alibaba Robot Co., Ltd., Hangzhou (CN)

(72) Inventors: Xianliang WANG, Hangzhou (CN); Hongbin SUO, Hangzhou (CN)

(21) Appl. No.: 18/685,032

(22) PCT Filed: Nov. 18, 2022
(86) PCT No.: PCT/CN2022/133015

§ 371 Date: Feb. 20, 2024

(30) Foreign Application Priority Data
Nov. 18, 2021 (CN) 202111365392.8

(51) Int. Cl. G10L 21/028; G10L 17/02; G10L 25/78

(52) U.S. Cl. CPC G10L 21/028; G10L 17/02; G10L 25/78

(57) ABSTRACT

A speech processing method, a device and a storage medium. The method includes: segmenting (401) to-be-processed speech according to role change point information in the to-be-processed speech to obtain multiple speech segments, where the role change point information is used to indicate a position where a speaking role changes in the to-be-processed speech, the multiple speech segments include multiple first segments and at least one second segment, and a length of any first segment is greater than a length of any second segment; performing (402) clustering on the multiple first segments, and assigning the at least one second segment to a class obtained after the clustering, to obtain a role separation result of the to-be-processed speech. The accuracy and stability of role separation are improved effectively.

The present application claims priority to Chinese patent application No. 202111365392.8, filed to China National Intellectual Property Administration on Nov. 18, 2021 and entitled “SPEECH PROCESSING METHOD, DEVICE AND STORAGE MEDIUM”, which is hereby incorporated by reference in its entirety.

### TECHNICAL FIELD

The present application relates to the field of audio processing technologies and, in particular, to a speech processing method, a device and a storage medium.

### BACKGROUND

Role separation technology can determine each part of speech is spoken by which role, and has a wide range of application requirements in fields such as a conference system.

In an existing role separation technology, speech is usually segmented first to obtain multiple speech segments of a preset duration, and then a similarity between every two segments is calculated. The segments are gradually merged based on similarity scores from high to low, and the merging is stopped when a similarity score is lower than a preset threshold, so as to obtain a role separation result.

The disadvantage of the prior art is that the result obtained by performing clustering on the speech segments of the preset duration is seriously fragmented, and the accuracy of role separation is poor, thereby affecting the user experience.

### SUMMARY

A main purpose of embodiments of the present application is to provide a speech processing method, a device and a storage medium, so as to reduce the fragmentation of a role separation result and improve the role separation effect.

In a first aspect, an embodiment of the present application provides a speech processing method, including:
obtaining single-channel speech corresponding to multiple participating roles collected by a conference system;
segmenting the single-channel speech according to role change point information in the single-channel speech to obtain multiple speech segments, where the role change point information is used to indicate a position where a speaking role changes in the single-channel speech, the multiple speech segments include multiple first segments and at least one second segment, and a length of any first segment is greater than a length of any second segment;
performing clustering on the multiple first segments, and assigning the at least one second segment to a class obtained after the clustering, to obtain a role separation result of the single-channel speech;
outputting speaking text corresponding to each participating role according to the role separation result and text information corresponding to the single-channel speech.

In a second aspect, an embodiment of the present application provides a speech processing method, including:
segmenting to-be-processed speech according to role change point information in the to-be-processed speech to obtain multiple speech segments, where the role change point information is used to indicate a position where a speaking role changes in the to-be-processed speech, the multiple speech segments include multiple first segments and at least one second segment, and a length of any first segment is greater than a length of any second segment;
performing clustering on the multiple first segments, and assigning the at least one second segment to a class obtained after the clustering, to obtain a role separation result of the to-be-processed speech.

In a third aspect, an embodiment of the present application provides a speech processing method, including:
segmenting to-be-processed speech to obtain multiple speech segments, where the multiple speech segments include multiple first segments and at least one second segment with lower credibility than the first segments;
performing clustering the multiple first segments, and assigning the at least one second segment to a class obtained after the clustering, to obtain a role separation result of the to-be-processed speech;
where credibility of a speech segment is used to characterize credibility of a clustering result obtained by clustering based on the speech segment.

In a fourth aspect, an embodiment of the present application provides a speech processing apparatus, including:
an obtaining module, configured to obtain single-channel speech corresponding to multiple participating roles collected by a conference system;
a first segmenting module, configured to segment the single-channel speech according to role change point information in the single-channel speech to obtain multiple speech segments, where the role change point information is used to indicate a position where a speaking role changes in the single-channel speech, the multiple speech segments include multiple first segments and at least one second segment, and a length of any first segment is greater than a length of any second segment;
a first processing module, configured to perform clustering on the multiple first segments, and assign the at least one second segment to a class obtained after the clustering, to obtain a role separation result of the single-channel speech;
an outputting module, configured to output speaking text corresponding to each participating role according to the role separation result and text information corresponding to the single-channel speech.

In a fifth aspect, an embodiment of the present application provides a speech processing apparatus, including:
a second segmenting module, configured to segment to-be-processed speech according to role change point information in the to-be-processed speech to obtain multiple speech segments, where the role change point information is used to indicate a position where a speaking role changes in the to-be-processed speech, the multiple speech segments include multiple first segments and at least one second segment, and a length of any first segment is greater than a length of any second segment;
a second processing module, configured to perform clustering on the multiple first segments, and assign the at least one second segment to a class obtained after the clustering, to obtain a role separation result of the to-be-processed speech.

In a sixth aspect, an embodiment of the present application provides a speech processing apparatus, including:
a third segmenting module, configured to segment to-be-processed speech to obtain multiple speech segments, where the multiple speech segments include multiple first segments and at least one second segment with lower credibility than the first segments;
a third processing module, configured to perform clustering on the multiple first segments, and assign the at least one second segment to a class obtained after the clustering, to obtain a role separation result of the to-be-processed speech;
where credibility of a speech segment is used to characterize credibility of a clustering result obtained by clustering based on the speech segment.

In a seventh aspect, an embodiment of the present application provides a speech processing device, including:
at least one processor; and
a memory communicatively connected with the at least one processor;
where the memory stores instructions executable by the at least one processor, and the instructions are executed by the at least one processor to cause the speech processing device to execute the method according to the first aspect or the second aspect or the third aspect.

In an eighth aspect, an embodiment of the present application provides a speech processing device, including: a processing apparatus and at least one of the following communicatively connected with the processing apparatus: a speech inputting apparatus, a displaying apparatus;
where the speech outputting apparatus is configured to collect to-be-analyzed speech and send the to-be-analyzed speech to the processing apparatus;
the displaying apparatus is configured to display a role separation result determined by the processing apparatus and/or speech-to-text information determined through the role separation result;
the processing apparatus is configured to execute the method according to the first aspect or the second aspect or the third aspect.

In a ninth aspect, an embodiment of the present application provides a computer-readable storage medium, where the computer-readable storage medium stores computer execution instructions, and when a processor executes the computer execution instructions, the method according to the first aspect or the second aspect or the third aspect is implemented.

In a tenth aspect, an embodiment of the present application provides a computer program product including a computer program, and when the computer program is executed by a processor, the method according to the first aspect or the second aspect or the third aspect is implemented.

According to the speech processing method, the device and the storage medium provided in the present application, the to-be-processed speech can be segmented according to the role change point information in the to-be-processed speech to obtain multiple speech segments. The role change point information is used to indicate the position where the speaking role changes in the to-be-processed speech. The multiple speech segments include multiple first segments and at least one second segment, and the length of any first segment is greater than the length of any second segment. The clustering is performed on the multiple first segments and the at least one second segment is assigned to the class obtained after the clustering to obtain the role separation result of the to-be-processed speech. In this way, it can be realized that classification of the second segment is guided based on a clustering result of the first segments, thereby greatly reducing the problem of fragmentation, and significantly improving the user experience effect. Moreover, a clustering termination condition is determined without depending on a threshold, so that better robustness is possessed under different environments and the accuracy and stability of role separation are improved effectively.

### BRIEF DESCRIPTION OF THE DRAWINGS

FIG. 1 is a schematic diagram of an application scenario of an embodiment of the present application.

FIG. 2 is a schematic flowchart of a speech processing method provided by an embodiment of the present application.

FIG. 3 is a schematic diagram of an application of a role separation result provided by an embodiment of the present application.

FIG. 4 is a schematic flowchart of another speech processing method provided by an embodiment of the present application.

FIG. 5 is a schematic diagram of a principle of role separation provided by an embodiment of the present application.

FIG. 6 is a schematic diagram of a principle of determining a speech window provided by an embodiment of the present application.

FIG. 7 is a schematic flowchart of a clustering method provided by an embodiment of the present application.

FIG. 8 is a schematic flowchart of another speech processing method provided by an embodiment of the present application.

FIG. 9 is a schematic flowchart of yet another speech processing method provided by an embodiment of the present application.

FIG. 10 is a schematic structural diagram of a speech processing apparatus provided by an embodiment of the present application.

FIG. 11 is a schematic structural diagram of another speech processing apparatus provided by an embodiment of the present application.

FIG. 12 is a schematic structural diagram of yet another speech processing apparatus provided by an embodiment of the present application.

FIG. 13 is a schematic structure diagram of a speech processing device provided by an embodiment of the present application.

FIG. 14 is a schematic structure diagram of another speech processing device provided by an embodiment of the present application.

Realization of purposes, functional features and advantages of the present application are further described with reference to accompanying drawings in conjunction with embodiments. These drawings and textual description are not intended to limit the scope of the concept of the present application in any way, but rather to illustrate the concept of the present application to those skilled in the art by referring to specific embodiments.

### DESCRIPTION OF EMBODIMENTS

Exemplary embodiments of the present application will be described in more detail below with reference to the accompanying drawings. Although exemplary embodiments of the present application are shown in the accompanying drawings, it should be understood that the present application can be implemented in various forms and should not be limited by the embodiments described herein. On the contrary, these embodiments are provided for thoroughly understanding the present application and completely conveying the scope of the present application to those skilled in the art.

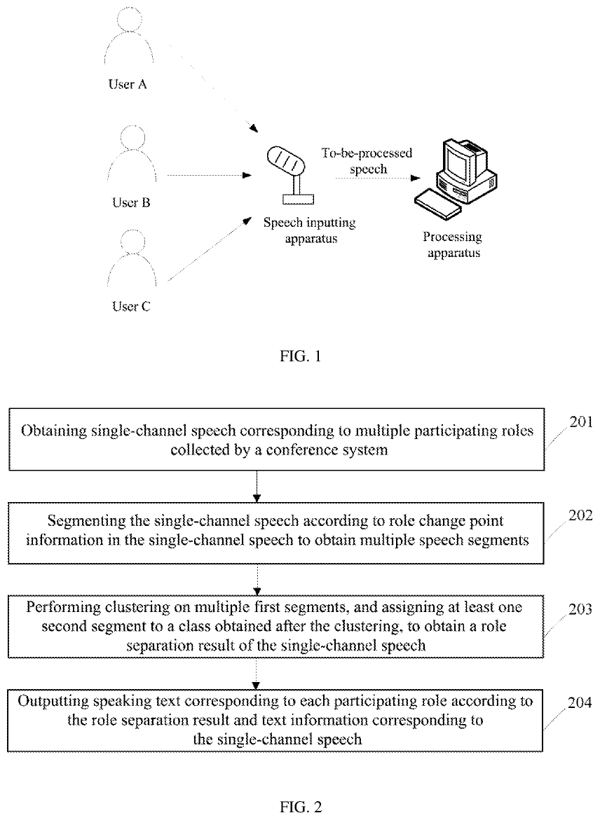

The embodiments of the present application can be used to implement role separation technology of speech and, in particular, to implement role separation of single-channel speech. FIG. 1 is a schematic diagram of an application scenario of an embodiment of the present application. As shown in FIG. 1, in a conference, multiple users A, B and C may use a same speech inputting apparatus, such as a microphone. The speech inputting apparatus transmits obtained to-be-processed speech of a single channel to a processing apparatus, and the processing apparatus performs role separation on the to-be-processed speech to distinguish a role corresponding to each part of the speech.

In some technologies, the speech may first be segmented according to a preset duration, such as 1 second, to obtain multiple 1-second segments. A feature of each segment is extracted, and a similarity between every two segments is calculated. Using a clustering algorithm, the segments are gradually merged based on similarity scores from high to low, and the merging is stopped when a similarity score is lower than a threshold.

This method has some problems in a practical conference system application as follows.

A clustering result obtained by performing pairwise merging on short-time speech segments is seriously fragmented, which affects the user experience effect. Moreover, since the threshold is used as a merging termination condition, due to the significant difference in scores under different noise environments and the significant difference in clustering effects under different environments, a result that far exceeds the actual quantity of roles is often obtained. Therefore, the accuracy and stability of the role separation result are poor.

In view of this, embodiments of the present application provide a speech processing method applicable to a conference system. Single-channel speech can be segmented according to a role change point. Clustering is first performed on long segments, and then short segments are assigned to corresponding class centers. In this way, it can be realized that classification of the short segments is guided based on a clustering result of the long segments, thereby greatly reducing the problem of fragmentation, and significantly improving the user experience effect. Moreover, the clustering termination condition is determined without depending on a threshold, so that better robustness is possessed under different environments and the accuracy and stability of role separation are improved effectively.

Some implementations of the present application will be described in detail below in conjunction with the accompanying drawings. In a case that there is no conflict between the embodiments, the following embodiments and features in the embodiments may be combined with each other, and the same or similar concepts or processes may not be repeated in some embodiments. In addition, a sequence of steps in the following method embodiments is only an example, and is not strictly limited.

FIG. 2 is a schematic flowchart of a speech processing method provided by an embodiment of the present application. The method in this embodiment may be applied to the scenario shown in FIG. 1, and an executive entity of the method may be any device with a data processing function, such as the processing apparatus in FIG. 1. Optionally, the speech inputting apparatus and the processing apparatus may be separate or integrated together. For example, the method provided by the embodiment of the present application may be implemented through an all-in-one conference system, or through a terminal such as a mobile phone, a computer, a tablet device and so on. Or, the terminal may send to-be-processed speech to a server, and the server feeds back a role separation result to the terminal after obtaining the result through the method provided by the embodiment of the present application.

As shown in FIG. 2, the method may include the following steps.

Step 201: obtaining single-channel speech corresponding to multiple participating roles collected by a conference system.

Optionally, the conference system may be implemented through hardware, software, or a combination of software and hardware. For example, a conference system may include the speech inputting apparatus and the processing apparatus as shown in FIG. 1. The speech inputting apparatus in the conference system collects speech corresponding to the multiple participating roles, and the speech is single-channel speech; or, the conference system may include an application program installed in a device, which can process the collected single-channel speech.

Step 202: segmenting the single-channel speech according to role change point information in the single-channel speech to obtain multiple speech segments.

The role change point information is used to indicate a position where a speaking role changes in the single-channel speech. The multiple speech segments include multiple first segments and at least one second segment, and a length of any first segment is greater than a length of any second segment.

Step 203: performing clustering on the multiple first segments, and assigning the at least one second segment to a class obtained after the clustering, to obtain a role separation result of the single-channel speech.

Optionally, specific implementations for performing segmenting, clustering and assigning on the collected speech can be found in other embodiments of the present application, and will not be described in detail here.

Step 204: outputting speaking text corresponding to each participating role according to the role separation result and text information corresponding to the single-channel speech.

Optionally, text recognition can be performed on the single-channel speech to obtain the corresponding text information, and then in combination with the role separation result, the speaking text corresponding to each participating role can be determined.

Different participating roles may be identified in different manners. For example, multiple participating roles may be identified as role ID1, role ID2, . . . , respectively; or, multiple participating roles may be identified as roles A, B, C, . . . , etc.

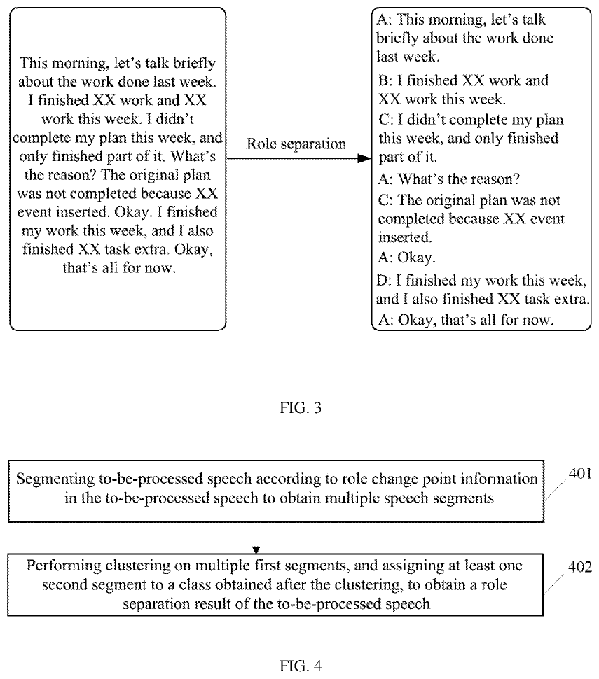

FIG. 3 is a schematic diagram of an application of a role separation result provided by an embodiment of the present application. As shown in FIG. 3, after a conference ends, text recognition can be performed on the to-be-processed speech collected in the conference to obtain corresponding text information. However, participating roles are not distinguished in the text information. According to the method provided by one or more embodiments of the present application, role separation can be performed on the collected single-channel speech, and the role separation result can be used to indicate a role ID corresponding to each speech segment, so as to determine a role to which each text part belongs in combination with the text information of the conference, and to label a speaking role for each sentence, thereby realizing conference recording and classification effectively and improving the user experience.

In the speech processing method provided by this embodiment, the single-channel speech corresponding to multiple participating roles collected by the conference system can be obtained, and the single-channel speech is segmented according to the role change point information in the single-channel speech to obtain the multiple speech segments. The role change point information is used to indicate the position where the speaking role changes in the single-channel speech. The multiple speech segments include multiple first segments and at least one second segment, and the length of any first segment is greater than the length of any second segment. The clustering is performed on the multiple first segments, and the at least one second segment is assigned to the class obtained after the clustering, to obtain the role separation result of the single-channel speech. The speaking text corresponding to each participating role is outputted according to the role separation result and the text information corresponding to the single-channel speech. In this way, role separation for the single-channel speech in the conference system can be realized quickly and accurately, and strong performance is possessed in different noise environments, thereby meeting conference requirements in different environments and improving the user experience.

In addition to the scenario shown in FIG. 1, the speech processing method provided by one or more embodiments of the present application may also be applied to any scenario that requires role separation. Examples are given in the following.

In an optional implementation, one or more embodiments of the present application may be applied to an education scenario, including an offline scenario and/or an online scenario. Involved roles have multiple identities, such as a teacher, a student, a teaching assistant, etc., and there may be at least one role for each identity. For example, there is one teacher and multiple students. Through an education assistance system, speech collected in a classroom and outside the classroom can be collected and processed, and separation of different roles can be implemented.

Optionally, in the education scenario, a speech processing method may include: obtaining to-be-processed speech that is outputted by multiple roles and collected by an education assistance system, where the to-be-processed speech outputted by the multiple roles is single-channel speech; segmenting the to-be-processed speech according to role change point information in the to-be-processed speech to obtain multiple speech segments, where the role change point information is used to indicate a position where a speaking role changes in the to-be-processed speech, the multiple speech segments include multiple first segments and at least one second segment, and a length of any first segment is greater than a length of any second segment; performing clustering on the multiple first segments, and assigning the at least one second segment to a class obtained after the clustering, to obtain a role separation result of the to-be-processed speech; extracting speaking information corresponding to at least some roles according to the role separation result of the to-be-processed speech, where the speaking information is in a form of speech and/or text.

Exemplarily, multiple students speak in a classroom discussion session.

Corresponding speech can be collected, and role separation can be performed using the method provided by the embodiment of the present application to obtain a speaking segment of each student. Part or all of the students' speaking information can be selected and displayed to the teacher, so as to facilitate evaluation and guidance by the teacher.

In another optional implementation, one or more embodiments of the present application may be applied to a court trial scenario. Through a court trial assistance system, speech collected at a court trial site can be processed, and then separation of different roles can be implemented.

Optionally, in the court trial scenario, a speech processing method may include: obtaining to-be-processed speech that is outputted by multiple roles and collected in a court trial site, where the to-be-processed speech is single-channel speech; segmenting the to-be-processed speech according to role change point information in the to-be-processed speech to obtain multiple speech segments, where the role change point information is used to indicate a position where a speaking role changes in the to-be-processed speech, the multiple speech segments include multiple first segments and at least one second segment, and a length of any first segment is greater than a length of any second segment; performing clustering on the multiple first segments, and assigning the at least one second segment to a class obtained after the clustering, to obtain a role separation result of the to-be-processed speech; generating a court trial record according to the role separation result of the to-be-processed speech and text information corresponding to the to-be-processed speech.

Exemplarily, during a court trial process, the speech in the court trial site can be collected, and role separation can be implemented for the speech through the method provided by the present application. Then the corresponding court trial record can be generated in combination with text corresponding to the speech, thereby improving the generation efficiency and accuracy of the court trial record, and providing a more efficient and reliable text record for the court trial.

In yet another optional implementation, one or more embodiments of the present application may be applied to sound recording organization. Specifically, one or more sound recordings may be organized, where collection objects of the sound recordings may be speech outputted by a person or a machine, and collection time of the sound recordings is not limited.

Optionally, in the sound recording organization scenario, a speech processing method may include: obtaining at least one piece of to-be-processed speech; segmenting the to-be-processed speech according to role change point information in the to-be-processed speech to obtain multiple speech segments, where the role change point information is used to indicate a position where a speaking role changes in the to-be-processed speech, the multiple speech segments include multiple first segments and at least one second segment, and a length of any first segment is greater than a length of any second segment; performing clustering on the multiple first segments, and assigning the at least one second segment to a class obtained after the clustering, to obtain a role separation result of the to-be-processed speech; organizing the at least one piece of the to-be-processed speech based on the role separation result.

Optionally, speech organization may include but is not limited to: classifying or sorting multiple pieces of speech according to roles; labeling the quantity of roles corresponding to each piece of speech; extracting multiple pieces of speech with a high degree of role coincidence; sorting roles appearing in at least one piece of speech according to durations; extracting speech segments corresponding to part or all roles in at least one piece of speech, or text corresponding to the speech segments, etc. Based on the role separation technology, the organization of speech or speech segments can be implemented quickly and accurately, which improves the effect of speech organization effectively and meets requirements of different users.

Detailed descriptions of speech processing processes and principles for implementing role separation in the present application are given below. The following speech processing processes may be applied to any of the above scenarios or other practical scenarios.

FIG. 4 is a schematic flowchart of another speech processing method provided by an embodiment of the present application. As shown in FIG. 4, the method may include the following steps.

Step 401: segmenting to-be-processed speech according to role change point information in the to-be-processed speech to obtain multiple speech segments.

Optionally, the method in this embodiment may be applied to any scenario. For example, in the conference scenario, the to-be-processed speech may be single-channel speech collected by a conference system; in the education scenario, the to-be-processed speech may be single-channel speech collected by an education assistance system; in the court trial scenario, the to-be-processed speech may be single-channel speech collected in a court trial site; in the sound recording organization scenario, the to-be-processed speech may be at least one piece of to-be-arranged speech. When applied to other scenarios, specific means for implementation are similar and will not be repeated here.

The role change point information is used to indicate a position where a speaking role changes in the to-be-processed speech. The multiple speech segments include multiple first segments and at least one second segment, and a length of any first segment is greater than a length of any second segment.

Exemplarily, the to-be-processed speech has 30 seconds, and the role change point information is used to indicate at which second the speaking role changes during these 30 seconds. The role change point information may include that the speaking role changes at the 5th second, the 15th second and the 20th second, then the to-be-processed speech may be segmented into at least four speech segments: a speech segment from the 0th second to the 5th second, a speech segment from the 5th second to the 15th second, a speech segment from the 15th second to the 20th second, and a speech segment from the 20th second to the 30th second. Each segment may correspond to a role, but it is not yet possible to distinguish a role ID corresponding to each speech segment.

In this embodiment, the multiple speech segments may be divided into long segments and short segments, which are referred to as first segments and second segments respectively. In the multiple speech segments, the length of any first segment may be greater than the length of any second segment.

Optional, the division of length can be set according to actual needs. For example, a segment exceeding 5 seconds may be considered as the first segment, and a segment less than or equal to 5 seconds may be considered as the second segment.

It should be noted that different speech segments may be completely separated, or a small amount of overlap may be allowed between different speech segments, so that each speech segment can include more information, thereby improving the role separation effect.

Step 402: performing clustering on the multiple first segments, and assigning the at least one second segment to a class obtained after the clustering, to obtain a role separation result of the to-be-processed speech.

Optionally, the clustering may be first performed on the multiple first segments, and the obtained clustering result may include multiple classes and a class center of each class. The quantity of classes is used to represent the quantity of roles corresponding to the to-be-processed speech, and the class center corresponding to each class may be used to represent a centroid corresponding to the first segment(s) of that class.

After obtaining the clustering result, the second segment may be assigned into the clustering result. Optionally, which class among the multiple classes each second segment is closest to may be determined, and the second segment is assigned to the closest class.

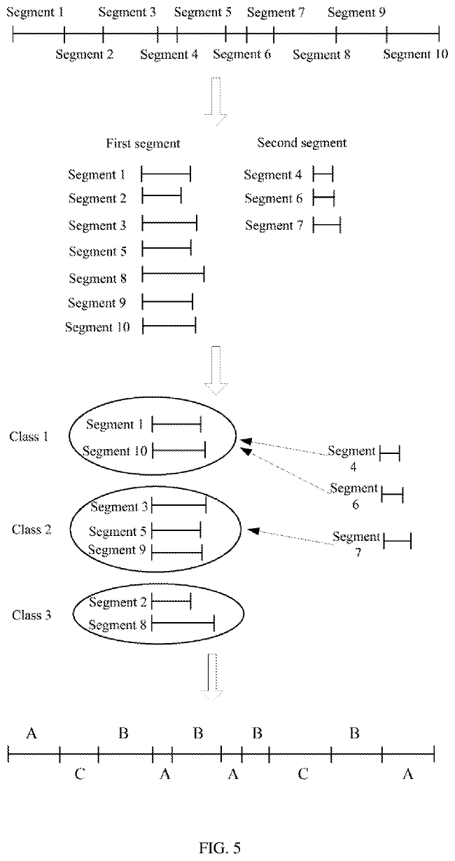

FIG. 5 is a schematic diagram of a principle of role separation provided by an embodiment of the present application. As shown in FIG. 5, the to-be-processed speech may be divided into 10 segments based on the role change point information, which are recorded as segments 1-10. Segments 1-3, 5 and 8-10 have a longer duration and belong to the first segments, while segments 4, 6 and 7 have a shorter duration and belong to the second segments.

The clustering is performed on multiple first segments to obtain three classes, where segments 1 and 10 belong to class 1, segments 3, 5 and 9 belong to class 2, and segments 2 and 8 belong to class 3. Then multiple second segments are assigned to these three classes, where segments 4 and 6 belong to class 1 and segment 7 belongs to class 2. Classes 1 to 3 may correspond to roles A, B and C respectively. Based on the clustering result and assigning result, the role corresponding to each part of the to-be-processed speech can be obtained. Thus, the to-be-processed speech is well labeled, which facilitates subsequent operations such as a speech-to-text conversion, and enhances the conference effect. In summary, in the speech processing method provided by the embodiments of the present application, the to-be-processed speech can be segmented according to the role change point information in the to-be-processed speech to obtain the multiple speech segments. The role change point information is used to indicate the position where the speaking role changes in the to-be-processed speech. The multiple speech segments include multiple first segments and at least one second segment, and the length of any first segment is greater than the length of any second segment. The clustering is performed on the multiple first segments and the at least one second segment is assigned to the class obtained after the clustering. In this way, it can be realized that classification of the second segment is guided based on the clustering result of the first segments, thereby greatly reducing the problem of fragmentation, and significantly improving the user experience effect. Moreover, a clustering termination condition is determined without depending on a threshold, so that better robustness is possessed under different environments, and the accuracy and stability of role separation are improved effectively.

In one or more embodiments of the present application, optionally, segmenting the to-be-processed speech according to the role change point information in the to-be-processed speech to obtain the multiple speech segments may include: determining at least one valid speech segment in the to-be-processed speech through voice activity endpoint detection; performing role change point detection on the valid speech segment, and segmenting the at least one valid speech segment into the multiple speech segments according to obtained role change point information; where each speech segment is speech corresponding to a single role.

The voice activity endpoint detection (Voice Activity Detection, VAD), also referred to as voice activity detection, can determine when a speaker starts to speak and stops speaking, such that an invalid speech segment in the to-be-processed speech can be removed and at least one valid speech segment can be obtained.

The role change point detection (Change point detection, CPD) can detect a position where a speaking role changes in speech. Performing the role change point detection on each speech segment in the at least one valid speech segment can further divide the at least one valid speech segment into multiple speech segments, and each speech segment may be considered as a speech segment of a single role.

Through the voice activity endpoint detection and the role change point detection, the to-be-processed speech can be quickly segmented into multiple speech segments, the invalid speech in the to-be-processed speech is removed, and the valid speech segment is further divided according to the position of role change, thereby improving the accuracy and efficiency of the subsequent clustering operation.

In other optional implementations, it may also be the case that the role change point detection is performed first to segment the to-be-processed speech into at least one speech segment, and then further segmentation is performed through the voice activity endpoint detection to obtain the multiple speech segments. Or, the voice activity endpoint detection may not be necessary, and the to-be-processed speech may be directly segmented into the multiple speech segments through the role change point detection.

In one or more embodiments of the present application, optionally, performing the role change point detection on the valid speech segment includes: determining at least one speech window corresponding to the valid speech segment based on a preset window length and/or a sliding duration, and extracting a feature of the speech window; determining the role change point information according to a similarity between features of adjacent speech windows.

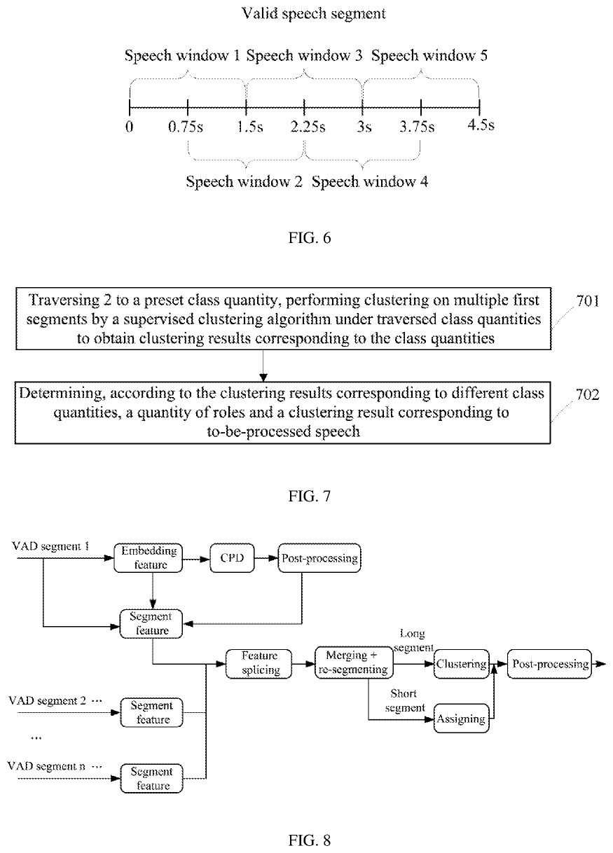

FIG. 6 is a schematic diagram of a principle of determining a speech window provided by an embodiment of the present application. As shown in FIG. 6, for any valid speech segment, the valid speech segment may be divided into multiple speech windows according to the preset window length and the sliding duration. For example, if the preset window length is 1.5 seconds and the sliding duration is 0.75 seconds, a valid speech segment with a duration of 4.5 seconds can be divided into five speech windows: 0-1.5 seconds, 0.75-2.25 seconds, 1.5-3 seconds, 2.25-3.75 seconds, and 3-4 seconds, respectively, which are recorded as speech windows 1-5, and there is a 0.75-second overlap between two adjacent speech windows.

After obtaining the speech window, the feature corresponding to each speech window may be extracted. Optionally, an embedding (embedding) feature of the speech window may be extracted through a method such as xvector (an embedding vector representation method based on a neural network model). The similarity between features of two adjacent speech windows is calculated, and the role change point detection may be performed according to the similarity.

Optionally, if the similarity between two adjacent speech windows is less than a certain similarity threshold, it is indicated that there may be a role change.

For example, if a similarity between speech window 1 and speech window 2, and a similarity between speech window 2 and speech window 3 are greater than the similarity threshold, a similarity between speech window 4 and speech window 5 is also greater than the similarity threshold, and only a similarity between speech window 3 and speech window 4 is less than the similarity threshold, then it may be considered that a role change has occurred between speech windows 3 and 4. The valid speech segment is further divided into two speech segments, and the two speech segments include speech windows 1-3 and speech windows 4-5, respectively.

Optionally, the valid speech segment may be divided based only on the preset window length, with no overlap between adjacent speech windows; or, the valid speech segment may be divided based only on the preset sliding duration, and the window length of each speech window may not be fixed. Specific values of the preset window length and the sliding duration can be adjusted according to actual needs, which are not limited in the embodiments of the present application.

Optionally, detection may be further performed on adjacent speech windows between adjacent valid speech segments. If a similarity between the last speech window in a former valid speech segment and the first speech window in a latter valid speech segment is greater than the similarity threshold, it may be considered that the two speech windows belong to the same role, and then the two speech windows may be merged to realize the detection of the role change between multiple valid speech segments.

By determining the at least one speech window corresponding to the valid speech segment based on the preset window length and/or the sliding duration, and extracting the feature of the speech window, the role change point information can be determined according to the similarity between the features of adjacent speech windows, so that the role change point can be detected based on a continuous changing situation of the features of the valid speech segment, thereby improving the detection accuracy.

In one or more embodiments of the present application, optionally, the features of the valid speech segment may be extracted in a parallel manner.

Determining the at least one speech window corresponding to the valid speech segment based on the preset window length and/or the sliding duration, and extracting the feature of the speech window may include: performing parallelization processing on respective valid speech segments by using multiple threads, and for each valid speech segment, determining at least one speech window corresponding to the valid speech segment based on the preset window length and/or the sliding duration, and extracting the feature of the speech window.

Specifically, multiple threads may be used, and each thread processes one or more valid speech segments. Each thread divides the valid speech segments to be processed into multiple speech windows and extracts the feature of each speech window. Optionally, multiple threads may be used to process multiple speech windows in parallel to further improve the efficiency of feature extraction.

Segmenting the at least one valid speech segment into the multiple speech segments according to the obtained role change point information may include: splicing features obtained after the parallelization processing in chronological order, and segmenting the at least one valid speech segment into the multiple speech segments in combination the role change point information.

Optionally, during parallel processing, time information may be carried, where the time information may be a position or a sequence number of each valid speech segment in the whole to-be-processed speech. After the parallel processing is completed, the obtained features can be spliced in chronological order, and the multiple speech segments for clustering or assigning can be obtained in combination with the role change point information, thereby improving the processing speed effectively.

In other optional implementations, the multiple valid speech segments may also be sequentially processed, so that there is no need to carry the time information. After the processing of all valid speech segments is completed, features of the multiple speech windows arranged in chronological order may be obtained directly.

In one or more embodiments of the present application, optionally, a post-processing operation may be performed on the speech segments before clustering.

Optionally, if there is a speech segment with the quantity of speech windows less than a preset threshold among the multiple speech segments, the speech segment may be merged with an adjacent speech segment, and the first segments and the second segments are distinguished according to multiple speech segments obtained after the merging operation.

Exemplarily, the preset threshold may be 2. After multiple speech segments are obtained through VAD and CPD segmentation, if any speech segment only includes a single speech window, this speech segment is merged with a previous speech segment or a subsequent speech segment. After the merging is completed, the obtained multiple speech segments are divided into the first segments and the second segments for clustering and assigning, thereby reducing fragmented speech segments, and further improving the accuracy of clustering.

In one or more embodiments of the present application, optionally, for each speech segment of the multiple speech segments, whether it belongs to the first segments or the second segments may be determined according to a threshold.

Optionally, if the quantity of speech windows included in the speech segment is greater than a quantity threshold, the speech segment is the first segment; if the quantity of speech windows included in the speech segment is less than the quantity threshold, the speech segment is the second segment.

Exemplarily, the quantity threshold may be 5. If a speech segment includes more than 5 speech windows, the speech segment is the first segment, and vice versa, the speech segment is the second segment. By using the quantity threshold, the speech segments can be divided quickly and accurately.

In other optional implementations, the threshold can also be adjusted dynamically according to a result of speech segmentation. For example, if a median of quantities of speech windows corresponding to the multiple speech segments is k, the quantity threshold may be adjusted to 0.5k, so that the threshold for dividing into long and short segments can be adjusted dynamically according to the actual situation of different pieces of to-be-processed speech, so as to meet application requirements in different environments and improve the applicability.

Or, for the obtained multiple speech segments, the first segments and the second segment may be obtained by dividing proportionally. For example, the first 70% in terms of the length may be divided into the first segments, and the last 30% may be divided into the second segments, so as to avoid having too many or too few first segments, and affecting subsequent clustering and assigning effects.

In one or more embodiments of the present application, optionally, performing the clustering on the multiple first segments, and assigning the at least one second segment to the class obtained after the clustering may include: calculating, for each first segment, a mean of a feature of at least one speech window corresponding to the first segment to obtain a feature corresponding to the first segment, and performing clustering on the multiple first segments according to features corresponding to the multiple first segments; calculating, for each second segment, a mean of a feature of at least one speech window corresponding to the second segment to obtain a feature corresponding to the second segment, and assigning the at least one second segment to the class obtained after the clustering according to a feature corresponding to at least one second segment.

Exemplarily, an embedding feature obtained for each 1.5-second speech window may be a 512-dimensional vector. Each first segment includes at least one speech window, and the mean of the feature of the at least one speech window is calculated to obtain a 512-dimensional vector, which can characterize the feature corresponding to the first segment as a whole. Similarly, the mean of the feature of the at least one speech window included in the second segment may be used to characterize the feature corresponding to the second segment as a whole. By extracting features through speech windows and further calculating the features of the first segment and the second segment, the features obtained finally can reflect speech characteristics of the first segment and the second segment more accurately, and then, clustering and assigning can be performed according to the features of the first segment and the second segment, thereby improving the accuracy of clustering and assigning effectively.

In other optional implementations, the features may also be extracted directly from the speech segments without using the speech windows, and steps of calculating the means may be omitted. Or, role change point detection may be performed without relying on the embedding feature, and after the detection is completed, the feature corresponding to each speech segment may be extracted for clustering or assigning.

Optionally, one or more embodiments of the present application may be applied to realize unsupervised role separation, where the unsupervised role separation may refer to obtaining the quantity of roles in speech and information about time when each role speaks in a case that actual role information is unknown.

Optionally, when performing the clustering, optional class quantities may be traversed to determine clustering results under the respective class quantities, and a final clustering result may be selected therefrom to realize overall unsupervised role separation.

FIG. 7 is a schematic flowchart of a clustering method provided by an embodiment of the present application. As shown in FIG. 7, performing clustering on the multiple first segments may include the following steps.

Step 701, traversing 2 to a preset class quantity, performing clustering on the multiple first segments by a supervised clustering algorithm under traversed class quantities to obtain clustering results corresponding to the class quantities.

The preset class quantity may be set according to actual needs, and the preset class quantity in the embodiment of the present application is recorded as M, where M is a positive integer greater than 2. Traverse 2 to M. For each value traversed, supervised clustering is performed using that value as a class quantity to obtain a clustering result for that class quantity, where the clustering result is used to indicate classes obtained by clustering under that class quantity and a class center corresponding to each class.

Optionally, a kmeans (kmeans) clustering algorithm may be used to implement the clustering of the multiple first segments.

Exemplarily, 2 may be selected first as the class quantity for the kmeans algorithm, and then class centers corresponding to two classes may be initialized and clustering is performed. The obtained clustering result indicates which one of these two classes each of the first segments belongs to, and class centers determined after the clustering. Similarly, 3 is then selected as the class quantity to obtain a corresponding clustering result, and so on, until clustering results corresponding to the class quantities from 2 to M are obtained.

Step 702: determining, according to the clustering results corresponding to different class quantities, the quantity of roles and a clustering result corresponding to the to-be-processed speech.

Optionally, determining, according to the clustering results corresponding to different class quantities, the quantity of roles and the clustering result corresponding to the to-be-processed speech may be implemented through the following manners.

Set a current class quantity to the preset class quantity, and repeat the following steps until a final clustering result is obtained: calculating an inter-class distance and an intra-class distance of a clustering result under the current class quantity; if the inter-class distance and the intra-class distance meet a requirement, the quantity of roles corresponding to the to-be-processed speech is the current class quantity, and the final clustering result is the clustering result under the current class quantity; if the inter-class distance and the intra-class distance do not meet the requirement, the current class quantity is reduced by one.

Optionally, the requirement may be set according to actual needs, for example, the inter-class distance is greater than the intra-class distance, or a ratio of the inter-class distance to the intra-class distance is within a preset range.

Exemplarily, whether the clustering result corresponding to the preset class quantity M meets the requirement is calculated first. Specifically, an intra-class distance and an inter-class distance corresponding to M classes in the clustering result may be calculated. If the inter-class distance is greater than the intra-class distance, it is determined that the requirement is met. The clustering result is the final clustering result, and the quantity of roles corresponding to the to-be-processed speech is M, where each role corresponds to a class.

If the inter-class distance is less than or equal to the intra-class distance in the clustering result corresponding to M, the requirement is not meet. Then whether the clustering result corresponding to M−1 meets the requirement is calculated, and if it meets the requirement, the clustering result is the final clustering result. Otherwise, calculation for M−2 is continued until a result that meets the requirement is obtained.

By sequentially calculating whether the inter-class distances and the intra-class distances of respective clustering results meet the requirement, the clustering result determined finally can be more accurate and the clustering accuracy can be improved.

In this embodiment, by traversing 2 to the preset class quantity, the clustering is performed on the multiple first segments by the supervised clustering algorithm under the traversed class quantities to obtain the clustering results corresponding to the class quantities, and the quantity of roles and the clustering result corresponding to the to-be-processed speech are determined according to the clustering results corresponding to different class quantities, so that unsupervised role separation can be achieved quickly and accurately without knowing the quantity of roles in advance.

In other optional implementations, the clustering result may also be calculated directly starting from the preset class quantity M, and whether the requirement is met is determined. If so, stop; if not, continue to calculate and determine a clustering result corresponding to a next class quantity without first traversing 2 to M and calculating clustering results for 2 to M, thereby improving the clustering efficiency effectively.

In other optional implementations, the traversing may also be cancelled. A neural network model may be used to analyze the to-be-processed speech to obtain the quantity of roles in the to-be-processed speech, and clustering is performed based on the quantity of roles, so as to realize overall unsupervised role separation.

In addition, one or more embodiments of the present application may also be applied to realize supervised role separation. Optionally, the quantity of roles may be inputted by a user, or determined according to conference information, and then clustering is performed based on the quantity of roles, so as to realize overall supervised role separation.

In one or more embodiments of the present application, optionally, assigning the at least one second segment to the class obtained after the clustering may include: assigning the second segment to a corresponding class according to a similarity between the second segment and each class center in the clustering result of the to-be-processed speech.

Exemplarily, the feature corresponding to the first segment may be a 512-dimensional vector, and after performing clustering on the multiple first segments, an obtained class center is used to represent a centroid of the first segment(s) under that class, which can also be represented by a 512-dimensional vector.

When assigning each second segment, a similarity may be calculated between the feature corresponding to the second segment, i.e. a 512-dimensional vector, and each class center, and a class to which the second segment belongs may be determined based on the similarity.

By performing the clustering according to the features of the multiple first segments first and then assigning the feature of the shorter second segment to a class center according to the clustering result, the feature of the second segment is more matched with a feature of the assigned class, and the assignment accuracy of the second segment is improved.

In one or more embodiments of the present application, optionally, a post-processing operation may also be performed on speech segments after the clustering.

Optionally, after determining the role corresponding to each speech segment, if there exists a speech segment with a duration less than a preset duration, and two adjacent speech segments before and after the speech segment correspond to the same role, the role corresponding to the speech segment is modified to the corresponding role of the two speech segments before and after it, and the speech segment is merged with the two adjacent speech segments before and after it.

Exemplarily, the preset duration may be 0.5 seconds. After clustering and assigning operations, if any speech segment is less than 0.5 seconds and corresponds to role A, and both a previous speech segment and a subsequent speech segment correspond to role B, then the role corresponding to that speech segment may be modified from A to B, thereby achieving smooth processing of role separation and improving the user experience.

Optionally, if there exists a speech segment with a duration less than the preset duration, and a previous speech segment and a subsequent speech segment correspond to different roles, then the speech segment may be merged with the previous speech segment or the subsequent speech segment according to feature similarities.

FIG. 8 is a schematic flowchart of another speech processing method provided by an embodiment of the present application. As shown in FIG. 8, a method of parallelized feature extraction plus clustering first and then assigning may be used to realize role separation, and may include the following steps.

Step a: performing VAD on to-be-processed speech to remove invalid speech from the speech and obtain valid speech segments.

As shown in FIG. 8, the valid speech segments may include VAD segment 1, VAD segment 2, . . . , and VAD segment n.

Step b: extracting an embedding feature for each valid speech segment.

Optionally, in order to improve the processing speed, a parallelized processing manner may be used. The embedding feature for each speech window is extracted using xvector on each valid speech segment according to a window length of 1.5 seconds and a sliding duration of 0.75 seconds.

Step c: performing CPD detection on each VAD segment to obtain role change point information in the VAD segments.

Optionally, for each VAD segment, the CPD detection can be achieved by utilizing embedding features of adjacent speech windows. After the CPD detection is completed, a post-processing operation may be performed to correct the speech segments obtained by segmenting by VAD plus CPD. After correction, features corresponding to the speech segments may be obtained.

By using the above method, the feature corresponding to each speech segment in VAD segment 1, VAD segment 2, . . . , and VAD segment n may be obtained.

Step d: splicing parallelized features in chronological order, and obtaining multiple speech segments in combination with the role change point information, where the multiple speech segments are classified according to the quantity of speech windows.

Optionally, this step may include feature splicing, merging and re-segmenting.

The splicing may refer to splicing multiple features obtained through parallel processing in chronological order. The merging and re-segmenting may refer to re-segmenting merged features according to role change points to obtain the multiple speech segments. According to the quantity of speech windows included in each speech segment, the speech segments are divided into long segments and short segments, corresponding to the first segments and the second segments described above, respectively.

Step e: calculating means for the long segments, and performing traversing from 2 to a maximum quantity of roles for supervised kmeans clustering.

Optionally, the mean may be calculated for the speech windows included in the long segment obtained in step d, so as to obtain a corresponding feature for each long segment, and a clustering result may be obtained through the Kmeans clustering algorithm and Speakercount. Speakercount may refer to the quantity of speakers, i.e., the quantity of roles. Supervised kmeans clustering may be performed by performing traversing from 2 to the maximum quantity of roles (i.e., the preset class quantity).

Step f: determining the quantity of roles by using the clustering result.

Optionally, inter-class distances and intra-class distances of clustering results under different class quantities may be calculated from the maximum quantity of roles to 2, and when an inter-class distance is greater than an intra-class distance, the obtained class quantity and clustering result are the final result.

Step g: assigning the short segments to class centers obtained in step f according to similarities.

Optionally, the mean of the features of the speech windows included in the short segment obtained in step d may be calculated, so as to obtain a feature corresponding to each short segment. Based on a similarity between the feature and a class center, the short segment is assigned to the corresponding class center to obtain an assignment (assignment) result.

Step h: performing post-processing on the result and updating the result for a point that is inconsistent with previous and subsequent role information.

Optionally, through steps a-g, the class corresponding to each speech segment can be obtained, and each class corresponds to a role ID. In order to improve the accuracy, the post-processing operation may be performed to correct a role corresponding to a very short speech segment (such as less than 0.5 seconds).

In this solution, the segments are classified according to a continuous duration (such as 5 speech windows as a boundary) when performing the clustering. Clustering for the long segments is first performed, then the short segments are assigned to cluster centers, and at the same time, the post-processing operation is used to update the point having inconsistent results with previous and subsequent ones, which greatly reduces the problem of fragmentation and improving the user experience. Moreover, this solution avoids using a threshold to determine a clustering termination condition, thereby having more stable effects and better robustness under different environments. On the same test set, the role separation accuracy of a traditional method is about 65%, and the separation accuracy of this solution can reach 92%.

On the basis of the technical solutions provided by the above embodiments, optionally, the embedding feature extraction method may also use different neural network results, such as TDNN (Time Delay Neural Network, time delay neural network), Resnet, etc. The clustering method may use kmeans or other clustering methods, such as AHC (Agglomerative hierarchical clustering, hierarchical clustering algorithm), various community clustering methods, etc.

FIG. 9 is a schematic flowchart of yet another speech processing method provided by an embodiment of the present application. As shown in FIG. 9, the method includes the following steps.

Step 901: segmenting to-be-processed speech to obtain multiple speech segments, where the multiple speech segments include multiple first segments and at least one second segment with lower credibility than the first segments.

The credibility of a speech segment is used to characterize credibility of a clustering result obtained by clustering based on the speech segment.

Optionally, the credibility of the speech segment may be determined by at least one of: a length of the speech segment, a position of the speech segment in the to-be-processed speech, a deep learning model. Among the multiple speech segments, those with credibility greater than a preset value are divided into the first segments, and those with credibility less than the preset value are divided into the second segments.

In an optional implementation, the credibility may be determined by the length of the speech segment. The longer the length, the higher the credibility, and the shorter the length, the lower the credibility.

Correspondingly, the multiple speech segments may be divided into multiple first segments and at least one second segment according to the length, where the length of any first segment is greater than the length of any second segment. The length may be expressed by a duration of the speech segment or a quantity of speech windows included.

Further, the to-be-processed speech may be segmented according to role change point information in the to-be-processed speech to obtain multiple speech segments, and then the first segments and the second segment may be distinguished. Specific processing methods can be found in the aforementioned embodiments, and will not be repeated here.

In another optional implementation, the credibility of the speech segment may be determined through the position of the speech segment in the to-be-processed speech. For example, it may be noisy at beginning and end of a conference, so the credibility of speech segments at beginning and end positions may be less than that of speech segments at other positions.

Optionally, the position of the speech segment with lower credibility may also be inputted by a user. For example, the user may input a position of each stage of the conference in the to-be-processed speech according to an actual conference situation, and the credibility of a discussion stage will be less than the credibility of an individual speaking stage. In this way, more suitable segments can be filtered out from multiple speech segments for clustering, and then other segments are assigned to the clustering result, thereby having fast processing speed and meeting requirements of different conference scenarios.

In yet another optional implementation, the credibility of each speech segment may be calculated through the deep learning model. Optionally, the deep learning model may be trained through training samples, and the training samples may include speech samples and corresponding labels. The labels may be obtained through manual labeling. After the training is completed, the to-be-processed speech may be inputted into the deep learning model to determine corresponding credibility. The credibility of the speech segment can be determined more quickly and accurately through the deep learning model.

In addition, the credibility may be determined by combining at least two of: the duration of the speech segment, the position of the speech segment in the to-be-processed speech, the deep learning model.

In an example, the duration and the position of the speech segment may be combined for analysis. If both the duration and the position meet certain requirements, the speech segment is divided into the first segment; otherwise, the speech segment is divided into the second segment.

In another example, the duration of the speech segment and the deep learning model may be combined for analysis. Only when the duration is greater than a certain threshold, the speech segment is sent to the deep learning model for credibility prediction, and whether the speech segment belongs to the first segment or the second segment is determined according to a prediction result, where those with a shorter duration are directly divided into the second segments.

In yet another example, the duration of the speech segment, the position of the speech segment and the deep learning model may be combined for analysis. If both the duration and the position meet certain requirements, the speech segment is sent to the deep learning model for credibility prediction, and whether the speech segment belongs to the first segment or the second segment is determined according to a prediction result. If the duration and the position do not meet the certain requirements, the speech segment is directly divided into the second segment.

By comprehensively analyzing the duration of the speech segment, the position of the speech segment and the deep learning model, the credibility of the speech segment can be determined more accurately, and the effect of subsequent clustering and assigning can be improved.

Step 902: performing clustering on the multiple first segments, and assigning the at least one second segment to a class obtained after the clustering, to obtain a role separation result of the to-be-processed speech.

Specific implementation principles and process of this step can be found in the aforementioned embodiments, and will not be repeated here.

According to the speech processing method provided by this embodiment, the to-be-processed speech can be segmented to obtain multiple speech segments, where the credibility of the speech segment is used to characterize the credibility of the clustering result obtained by clustering based on the speech segment, and the multiple speech segments include multiple first segments and at least one second segment with the lower credibility than the first segments. The clustering is performed on the multiple first segments, and the at least one second segment is assigned to the class obtained after the clustering, to obtain the role separation result of the to-be-processed speech. In this way, it can be realized that classification of the segments with lower credibility is guided based on the clustering result of the segments with higher credibility, thereby greatly reducing the problem of fragmentation, and significantly improving the user experience effect. Moreover, a clustering termination condition is determined without depending on a threshold, so that better robustness is possessed under different environments, and the accuracy and stability of role separation are improved effectively.

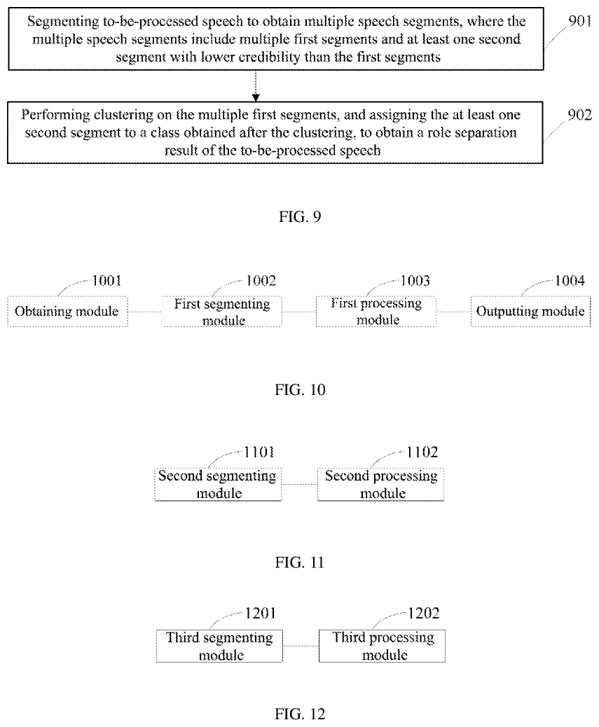

FIG. 10 is a schematic structural diagram of a speech processing apparatus provided by an embodiment of the present application. As shown in FIG. 10, the speech processing apparatus may include:

an obtaining module 1001, configured to obtain single-channel speech corresponding to multiple participating roles collected by a conference system;

a first segmenting module 1002, configured to segment the single-channel speech according to role change point information in the single-channel speech to obtain multiple speech segments, where the role change point information is used to indicate a position where a speaking role changes in the single-channel speech, the multiple speech segments include multiple first segments and at least one second segment, and a length of any first segment is greater than a length of any second segment;

a first processing module 1003, configured to perform clustering on the multiple first segments, and assign the at least one second segment to a class obtained after the clustering, to obtain a role separation result of the single-channel speech;

an outputting module 1004, configured to output speaking text corresponding to each participating role according to the role separation result and text information corresponding to the single-channel speech.

The speech processing apparatus provided by this embodiment can be used to execute the technical solutions provided by the embodiments shown in FIG. 1-FIG. 3, and the implementation principles and technical effects thereof are similar and will not be repeated here.

FIG. 11 is a schematic structural diagram of another speech processing apparatus provided by an embodiment of the present application. As shown in FIG. 11, the speech processing apparatus may include:

a second segmenting module 1101, configured to segment to-be-processed speech according to role change point information in the to-be-processed speech to obtain multiple speech segments, where the role change point information is used to indicate a position where a speaking role changes in the to-be-processed speech, the multiple speech segments include multiple first segments and at least one second segment, and a length of any first segment is greater than a length of any second segment;

a second processing module 1102, configured to perform clustering on the multiple first segments, and assign the at least one second segment to a class obtained after the clustering, to obtain a role separation result of the to-be-processed speech.

In one or more embodiments of the present application, the second segmenting module 1101 is specifically configured to: determine at least one valid speech segment in the to-be-processed speech through voice activity endpoint detection; perform role change point detection on the valid speech segment, and segment the at least one valid speech segment into the multiple speech segments according to obtained role change point information; where each speech segment is speech corresponding to a single role.

In one or more embodiments of the present application, when performing the role change point detection on the valid speech segment, the second segmenting module 1101 is specifically configured to: determine at least one speech window corresponding to the valid speech segment based on a preset window length and/or a sliding duration, and extract a feature of the speech window; determine the role change point information according to a similarity between features of adjacent speech windows.

In one or more embodiments of the present application, when determining the at least one speech window corresponding to the valid speech segment based on the preset window length and/or the sliding duration, and extracting the feature of the speech window, the second segmenting module 1101 is specifically configured to: perform parallelization processing on respective valid speech segments by using multiple threads, and for each valid speech segment, determine at least one speech window corresponding to the valid speech segment based on the preset window length and/or the sliding duration, and extract the feature of the speech window. In one or more embodiments of the present application, when segmenting the at least one valid speech segment into the multiple speech segments according to the obtained role change point information, the second segmenting module 1101 is specifically configured to: splice features obtained after the parallelization processing in chronological order, and segment the at least one valid speech segment into the multiple speech segments in combination with the role change point information.

In one or more embodiments of the present application, if a quantity of speech windows included in the speech segment is greater than a quantity threshold, the speech segment is the first segment; if the quantity of speech windows included in the speech segment is less than the quantity threshold, the speech segment is the second segment.

In one or more embodiments of the present application, the second processing module 1102 is specifically configured to: calculate, for each first segment, a mean of a feature of at least one speech window corresponding to the first segment to obtain a feature corresponding to the first segment, and perform clustering on the multiple first segments according to features corresponding to the multiple first segments; calculate, for each second segment, a mean of a feature of at least one speech window corresponding to the second segment to obtain a feature corresponding to the second segment, and assign the at least one second segment to the class obtained after clustering according to a feature corresponding to at least one second segment.

In one or more embodiments of the present application, when performing the clustering on the multiple first segments, the second processing module 1102 is specifically configured to: traverse 2 to a preset class quantity, perform clustering on the multiple first segments by a supervised clustering algorithm under traversed class quantities to obtain clustering results corresponding to the class quantities; determine, according to the clustering results corresponding to different class quantities, a quantity of roles and a clustering result corresponding to the to-be-processed speech.

In one or more embodiments of the present application, when determining, according to the clustering results corresponding to different class quantities, the quantity of roles and the clustering result corresponding to the to-be-processed speech, the second processing module 1102 is specifically configured to: set a current class quantity to the preset class quantity, and repeat the following steps until a final clustering result is obtained: calculating an inter-class distance and an intra-class distance of a clustering result under the current class quantity; if the inter-class distance and the intra-class distance meet a requirement, the quantity of roles corresponding to the to-be-processed speech is the current class quantity, and the final clustering result is the clustering result under the current class quantity; if the inter-class distance and the intra-class distance do not meet the requirement, the current class quantity is reduced by one.

In one or more embodiments of the present application, when assigning the at least one second segment to the class obtained after the clustering, the second processing module 1102 is specifically configured to: assign the second segment to a corresponding class according to a similarity between the second segment and each class center in the clustering result of the to-be-processed speech.

In one or more embodiments of the present application, the second processing module 1102 is further configured to: if there is a speech segment with the quantity of speech windows less than a preset threshold among the multiple speech segments obtained by segmenting, merge the speech segment with an adjacent speech segment, and distinguish the first segments and the second segment according to speech segments obtained after a merging operation; and/or, after determining a role corresponding to each speech segment, if there is a speech segment with a duration less than a preset duration, and two adjacent speech segments before and after the speech segment correspond to a same role, merge the speech segment with the two adjacent speech segments before and after the speech segment.

The speech processing apparatus provided by this embodiment can be used to execute the technical solutions provided by the embodiments shown in FIG. 4-FIG. 8, and the implementation principles and technical effects are similar and will not be repeated here.

FIG. 12 is a schematic structure diagram of yet another speech processing apparatus provided by an embodiment of the present application. As shown in FIG. 12, the speech processing apparatus may include:

a third segmenting module 1201, configured to segment to-be-processed speech to obtain multiple speech segments, where the multiple speech segments include multiple first segments and at least one second segment with lower credibility than the first segments;

a third processing module 1202, configured to perform clustering on the multiple first segments, and assign the at least one second segment to a class obtained after the clustering, to obtain a role separation result of the to-be-processed speech;

where credibility of a speech segment is used to characterize credibility of a clustering result obtained by clustering based on the speech segment.

In one or more embodiments of the present application, the third segmenting module 1201 is further configured to determine the credibility of the speech segment by at least one of: a length of the speech segment, a position of the speech segment in the to-be-processed speech, a deep learning model.

The speech processing apparatus provided by this embodiment can be used to execute the technical solution provided by the embodiment shown in FIG. 9, and the implementation principles and technical effects thereof are similar and will not be repeated here.

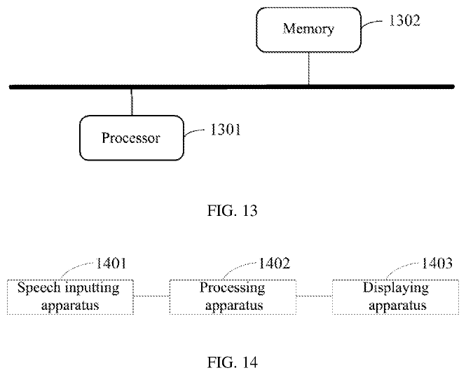

FIG. 13 is a schematic structural diagram of a speech processing device provided by an embodiment of the present application. As shown in FIG. 13, the speech processing device of this embodiment may include: at least one processor 1301; and a memory 1302 communicatively connected with the at least one processor; where the memory 1302 stores instructions that are executable by the at least one processor 1301, and the instructions are executed by the at least one processor 1301 to cause the speech processing device to execute the method according to any of the above embodiments.

Optionally, the memory 1302 may be either stand-alone or integrated with the processor 1301.

The implementation principles and technical effects of the speech processing device provided by this embodiment can be found in the aforementioned embodiments, and will not be repeated here.

FIG. 14 is a schematic structural diagram of another speech processing device provided by an embodiment of the present application. As shown in FIG. 14, the speech processing device of this embodiment may include: a processing apparatus 1402 and at least one of the following communicatively connected with the processing apparatus: a speech inputting apparatus 1401, a displaying apparatus 1403;

where the speech inputting apparatus 1401 is configured to collect to-be-analyzed speech and send the to-be-analyzed speech to the processing apparatus 1402; the displaying apparatus 1403 is configured to display a role separation result determined by the processing apparatus 1402 and/or speech-to-text information determined through the role separation result; the processing apparatus 1402 is configured to execute the speech processing method according to any of the aforementioned embodiments.

Optionally, the speech inputting apparatus 1401 may be an apparatus capable of collecting speech, such as a microphone, and the displaying apparatus 1403 may an apparatus with a display function, such as a display screen.

Optionally, the processing apparatus 1402, the speech inputting apparatus 1401 and the displaying apparatus 1403 may be integrated together or disposed separately. The speech inputting apparatus 1401, the displaying apparatus 1403 and the processing apparatus 1402 may implement communication connection in a wired or wireless manner.

The displaying apparatus 1403 may display the role separation result determined by the processing apparatus 1402, such as displaying which role is speaking from which second to which second, or displaying the speech-to-text information determined through the role separation result. The speech-to-text information may be text information including the role separation result, and the text information is the text information corresponding to the to-be-processed speech. For example, a speech-to-text result may be content displayed on a right part of FIG. 3, and of course, the role separation result and the speech-to-text information may also be displayed simultaneously or sequentially, thereby facilitating the user to view the conference records and improving the user experience.

The implementation principles and technical effects of the speech processing device provided by this embodiment can be found in the aforementioned embodiments, and will not be repeated here.

An embodiment of the present application further provides a computer-readable storage medium, where the computer-readable storage medium stores computer execution instructions, and when a processor executes the computer execution instructions, the method according to any of the aforementioned embodiments is implemented.

An embodiment of the present application further provides a computer program product, including a computer program, and when the computer program is executed by a processor, the method according to any of the aforementioned embodiments is implemented.

In the several embodiments provided by the present application, it should be understood that disclosed devices and methods may be implemented in other ways. For example, device embodiments described above are only illustrative, e.g., the division of modules is only a logical function division, and there may be other division manners in actual implementation, for example, multiple modules may be combined or integrated into another system, or some features may be ignored or not executed.

An integrated module implemented in a form of software functional module mentioned above may be stored in a computer-readable storage medium. The software functional module is stored in the storage medium, including several instructions to enable a computer device (which may be a personal computer, a server, or a network device, etc.) or a processor to execute some steps of the methods described in various embodiments of the present application.

It should be understood that the processor may be a central processing unit (Central Processing Unit, CPU), or may be other general-purpose processors, digital signal processors (Digital Signal Processors, DSPs), application specific integrated circuits (Application Specific Integrated Circuits, ASICs), etc. A general-purpose processor may be a microprocessor or any conventional processor. Method steps disclosed in the present application may be directly embodied as being executed and completed by a hardware processor, or by a combination of hardware and software modules in a processor.

The memory may include a high-speed RAM memory, and may also include a non-volatile memory NVM, such as at least one disk memory, and the memory may also be a U disk, a portable hard disk, a read-only memory, a magnetic disk or an optical disc, etc.

The storage medium may be implemented by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disc. The storage medium may be any available medium that can be accessed by a general-purpose or dedicated computer.

An exemplary storage medium is coupled to a processor to cause the processor to read information from the storage medium and write information to the storage medium. Of course, the storage medium may also be an integral part of the processor. The processor and the storage medium may be located in an application specific integrated circuit (Application Specific Integrated Circuit, ASIC). Of course, the processor and the storage medium may also exist as discrete components in an electronic device or a main control device.

It should be noted that, as used herein, terms “including”, “comprising”, or any other variation thereof are intended to cover non-exclusive inclusion, such that a process, method, article or apparatus including a series of elements not only includes those elements, but also includes other elements that are not explicitly listed, or also includes elements inherent to such process, method, article or apparatus. Without further limitations, an element defined by a statement “including a . . . ” does not exclude the existence of other identical elements in the process, method, article or apparatus including that element.

The above serial numbers of the embodiments of the present application are only for description and do not represent advantages or disadvantages of the embodiments.

Through the description of the implementations, those skilled in the art can clearly understand that the above embodiment methods may be implemented through software plus necessary general hardware platform, and of course, may also be implemented through hardware. However, in many cases, the former is the better implementation. Based on this understanding, the essence of the technical solutions of the present application or the part that contributes to the prior art may be embodied in the form of a software product. The computer software product is stored in a storage medium (such as a ROM/RAM, a magnetic disc, an optical disc), including several instructions to cause a terminal device (which may be a mobile phone, a computer, a server, an air conditioner, or a network device, etc.) to execute the methods described in various embodiments of the present application.

The above are only preferred embodiments of the present application and are not intended to limit the patent scope of the present application. Any equivalent structure or equivalent process changes made by using the contents of the specification and drawings of the present application, or direct or indirect applications in other related technical fields, are all similarly included in the patent protection scope of the present application.

1. A speech processing method, comprising:
obtaining single-channel speech corresponding to multiple participating roles collected by a conference system;
segmenting the single-channel speech according to role change point information in the single-channel speech to obtain multiple speech segments, wherein the role change point information is used to indicate a position where a speaking role changes in the single-channel speech, the multiple speech segments comprise multiple first segments and at least one second segment, and a length of any first segment is greater than a length of any second segment;
performing clustering on the multiple first segments, and assigning the at least one second segment to a class obtained after the clustering, to obtain a role separation result of the single-channel speech;
outputting speaking text corresponding to each participating role according to the role separation result and text information corresponding to the single-channel speech.

2. A speech processing method, comprising:
segmenting to-be-processed speech according to role change point information in the to-be-processed speech to obtain multiple speech segments, wherein the role change point information is used to indicate a position where a speaking role changes in the to-be-processed speech, the multiple speech segments comprise multiple first segments and at least one second segment, and a length of any first segment is greater than a length of any second segment;
performing clustering on the multiple first segments, and assigning the at least one second segment to a class obtained after the clustering, to obtain a role separation result of the to-be-processed speech.

3. The method according to claim 2, wherein segmenting the to-be-processed speech according to the role change point information in the to-be-processed speech to obtain the multiple speech segments comprises:
determining at least one valid speech segment in the to-be-processed speech through voice activity endpoint detection;
performing role change point detection on the valid speech segment, and segmenting the at least one valid speech segment into the multiple speech segments according to obtained role change point information;
wherein each speech segment is speech corresponding to a single role.

4. The method according to claim 3, wherein performing the role change point detection on the valid speech segment comprises:
determining at least one speech window corresponding to the valid speech segment based on a preset window length and/or a sliding duration, and extracting a feature of the speech window;
determining the role change point information according to a similarity between features of adjacent speech windows.

5. The method according to claim 4, wherein determining the at least one speech window corresponding to the valid speech segment based on the preset window length and/or the sliding duration, and extracting the feature of the speech window comprises:
performing parallelization processing on respective valid speech segments by using multiple threads, and for each valid speech segment, determining at least one speech window corresponding to the valid speech segment based on the preset window length and/or the sliding duration, and extracting the feature of the speech window;
correspondingly, segmenting the at least one valid speech segment into the multiple speech segments according to the obtained role change point information comprises:
splicing features obtained after the parallelization processing in chronological order, and segmenting the at least one valid speech segment into the multiple speech segments in combination with the role change point information.

6. The method according to claim 4, wherein performing the clustering on the multiple first segments, and assigning the at least one second segment to the class obtained after the clustering comprises:
calculating, for each first segment, a mean of a feature of at least one speech window corresponding to the first segment to obtain a feature corresponding to the first segment, and performing clustering on the multiple first segments according to features corresponding to the multiple first segments;
calculating, for each second segment, a mean of a feature of at least one speech window corresponding to the second segment to obtain a feature corresponding to the second segment, and assigning the at least one second segment to the class obtained after clustering according to a feature corresponding to at least one second segment.

7. The method according to claim 2, wherein performing the clustering on the multiple first segments comprises:
traversing 2 to a preset class quantity, performing clustering on the multiple first segments by a supervised clustering algorithm under traversed class quantities to obtain clustering results corresponding to the class quantities;
determining, according to the clustering results corresponding to different class quantities, a quantity of roles and a clustering result corresponding to the to-be-processed speech.

8. The method according to claim 7, wherein determining, according to the clustering results corresponding to different class quantities, the quantity of roles and the clustering result corresponding to the to-be-processed speech comprises:
setting a current class quantity to the preset class quantity, and repeating the following steps until a final clustering result is obtained:
calculating an inter-class distance and an intra-class distance of a clustering result under the current class quantity;
if the inter-class distance and the intra-class distance meet a requirement, the quantity of roles corresponding to the to-be-processed speech is the current class quantity, and the final clustering result is the clustering result under the current class quantity;
if the inter-class distance and the intra-class distance do not meet the requirement, the current class quantity is reduced by one.

9. A speech processing method, comprising:
segmenting to-be-processed speech to obtain multiple speech segments, wherein the multiple speech segments comprise multiple first segments and at least one second segment with lower credibility than the first segments;
performing clustering on the multiple first segments, and assigning the at least one second segment to a class obtained after the clustering, to obtain a role separation result of the to-be-processed speech;
wherein credibility of a speech segment is used to characterize credibility of a clustering result obtained by clustering based on the speech segment.

10-12. (canceled)

13. A speech processing device, comprising:
at least one processor; and
a memory communicatively connected with the at least one processor;
wherein the memory stores instructions executable by the at least one processor, and the instructions are executed by the at least one processor to cause the speech processing device to execute the method according to claim 2.

14. A speech processing device, comprising: a processing apparatus and at least one of the following communicatively connected with the processing apparatus: a speech inputting apparatus, a displaying apparatus;
wherein the speech inputting apparatus is configured to collect to-be-analyzed speech and send the to-be-analyzed speech to the processing apparatus;
the displaying apparatus is configured to display a role separation result determined by the processing apparatus and/or speech-to-text information determined through the role separation result;
the processing apparatus is configured to execute the method according to claim 2.

15. A non-transitory computer-readable storage medium, wherein the computer-readable storage medium stores computer execution instructions, and when a processor executes the computer execution instructions, the method according to claim 2 is implemented.

16. (canceled)

17. The speech processing device according to claim 13, wherein the instructions are executed by the at least one processor to cause the speech processing device to execute the following operations:
determining at least one valid speech segment in the to-be-processed speech through voice activity endpoint detection;
performing role change point detection on the valid speech segment, and segmenting the at least one valid speech segment into the multiple speech segments according to obtained role change point information;
wherein each speech segment is speech corresponding to a single role.

18. The speech processing device according to claim 17, wherein the instructions are executed by the at least one processor to cause the speech processing device to further execute the following operations:
determining at least one speech window corresponding to the valid speech segment based on a preset window length and/or a sliding duration, and extracting a feature of the speech window;
determining the role change point information according to a similarity between features of adjacent speech windows.

19. The speech processing device according to claim 18, wherein the instructions are executed by the at least one processor to cause the speech processing device to further execute the following operations:
performing parallelization processing on respective valid speech segments by using multiple threads, and for each valid speech segment, determining at least one speech window corresponding to the valid speech segment based on the preset window length and/or the sliding duration, and extracting the feature of the speech window;
splicing features obtained after the parallelization processing in chronological order, and segmenting the at least one valid speech segment into the multiple speech segments in combination with the role change point information.

20. The speech processing device according to claim 18, wherein the instructions are executed by the at least one processor to cause the speech processing device to further execute the following operations:
calculating, for each first segment, a mean of a feature of at least one speech window corresponding to the first segment to obtain a feature corresponding to the first segment, and performing clustering on the multiple first segments according to features corresponding to the multiple first segments;
calculating, for each second segment, a mean of a feature of at least one speech window corresponding to the second segment to obtain a feature corresponding to the second segment, and assigning the at least one second segment to the class obtained after clustering according to a feature corresponding to at least one second segment.

21. The speech processing device according to claim 13, wherein the instructions are executed by the at least one processor to cause the speech processing device to further execute the following operations:
traversing 2 to a preset class quantity, performing clustering on the multiple first segments by a supervised clustering algorithm under traversed class quantities to obtain clustering results corresponding to the class quantities;
determining, according to the clustering results corresponding to different class quantities, a quantity of roles and a clustering result corresponding to the to-be-processed speech.

22. The speech processing device according to claim 21, wherein the instructions are executed by the at least one processor to cause the speech processing device to further execute the following operations:
setting a current class quantity to the preset class quantity, and repeating the following steps until a final clustering result is obtained:
calculating an inter-class distance and an intra-class distance of a clustering result under the current class quantity;
if the inter-class distance and the intra-class distance meet a requirement, the quantity of roles corresponding to the to-be-processed speech is the current class quantity, and the final clustering result is the clustering result under the current class quantity;
if the inter-class distance and the intra-class distance do not meet the requirement, the current class quantity is reduced by one.

23. A speech processing device, comprising:
at least one processor; and
a memory communicatively connected with the at least one processor;
wherein the memory stores instructions executable by the at least one processor, and the instructions are executed by the at least one processor to cause the speech processing device to execute the method according to claim 1.

24. A speech processing device, comprising:
at least one processor; and
a memory communicatively connected with the at least one processor;
wherein the memory stores instructions executable by the at least one processor, and the instructions are executed by the at least one processor to cause the speech processing device to execute the method according to claim 9.
